(19) United States
(12) Patent Application Publication
(10) Pub. No.: US 2019/0012726 A1
(43) Pub. Date: Jan. 10, 2019

(54) SUPPLEMENTARY DATA DISPLAY DURING BROWSING

(71) Applicant: The Toronto-Dominion Bank, Totonto (CA)

(72) Inventors: Dino Paul D'AGOSTINO, Toronto (CA); Satwinder Singh BRAR, Toronto (CA); Arun Victor JAGGA, Toronto (CA); John Jong-Suk LEE, Toronto (CA)

(21) Appl. No.: 15/644,880

(22) Filed: Jul. 10, 2017

(51) Int. Cl. G06Q 30/06; H04L 29/08; G06F 21/62

(52) U.S. Cl. CPC G06Q 30/0641; H04L 67/02; G06F 17/2705; H04L 67/141; G06F 21/6245; H04L 67/306

(57) ABSTRACT

Device and methods are described for obtaining supplementary data based on a document retrieved at an electronic device. In an aspect, a processor is configured to: establish a communications session via the communication interface with a first server based on authorization information received at the input interface, the authorization information associated with a profile stored at the first server; parse a first document retrieved by the application module to identify one or more attributes; during the communications session, transmit a signal to the first server via the communication interface, the signal representing a first supplementary data request, the first supplementary data request based on one or more of the identified attributes for the first document; receive first supplementary data from the first server, the first supplementary data based on the profile; and display on the display the first supplementary data in association with related data from the first document.

### FIELD

The present application generally relates to network-based document retrieval and, more particularly, to methods and devices for providing supplementary data based on browsing activity on an electronic device.

### BACKGROUND

The Internet has become an increasingly useful resource for parties researching and buying property. For example, the Internet is commonly used for researching vehicles, appliances, real property, etc. The Internet is also commonly used for ecommerce to allow users to purchase goods while online.

However, despite their ubiquity, e-commerce websites and websites used to research property provide limited functions to assist a user in researching goods and property. For example, automotive-sale websites often provide only very basic financing information making it difficult for a user to determine the true cost of buying and operating an automobile. In order to determine the true cost, a user may need to contact a financing company to determine the terms of financing that they are eligible for and may need to contact an insurance company to determine insurance rates for that automobile.

There is a need for improved computer-systems which rapidly provide data that may be relevant to a specific user while protecting the privacy of data associated with that user.

### BRIEF DESCRIPTION OF THE DRAWINGS

Reference will now be made, by way of example, to the accompanying drawings which show example embodiments of the present application, and in which:

FIG. 1 is a block diagram of an example operating environment in which example embodiments of the present disclosure may be applied;

FIG. 2 is a block diagram of an example electronic device in accordance with example embodiments of the present disclosure;

FIG. 3 is a block diagram of an example server in accordance with example embodiments of the present disclosure;

FIG. 4 is a flowchart of a method to obtain and display supplementary data based on a document retrieved at an electronic device;

FIG. 5 is an example display screen which displays supplementary data and a document related to the supplementary data;

FIG. 6 is a flowchart of a method for obtaining and sending supplementary data based on attributes associated with a document;

FIG. 7 is a flowchart of a method to obtain and display first and second supplementary data based on first and second documents; and

FIG. 8 is an example display screen which displays a comparison view based on supplementary data.

Similar reference numerals may have been used in different figures to denote similar components.

### DESCRIPTION OF EXAMPLE EMBODIMENTS

In one aspect, the present application describes an electronic device. The electronic device includes an input interface, a display, a communication interface and a memory storing an application module. The electronic device also includes a processor coupled to the input interface, the communication interface, the display and the memory. The processor is configured to: establish a communications session via the communication interface with a first server based on authorization information received at the input interface, the authorization information associated with a profile stored at the first server; parse a first document retrieved by the application module to identify one or more attributes; during the communications session, transmit a signal to the first server via the communication interface, the signal representing a first supplementary data request, the first supplementary data request based on one or more of the identified attributes for the first document; receive first supplementary data from the first server, the first supplementary data based on the profile; and display on the display the first supplementary data in association with related data from the first document.

In another aspect, the present application describes a computer-implemented method. The method includes: i) establishing a communications session between an electronic device and a first server based on authorization information received at an input interface associated with the electronic device, the authorization information associated with a profile stored at the first server; ii) parsing, by the electronic device, a first document retrieved by an application module to identify one or more attributes; iii) during the communications session, transmitting a signal to the first server via a communication interface of the electronic device, the signal representing a first supplementary data request, the first supplementary data request based on one or more of the identified attributes for the first document; iv) receiving first supplementary data from the first server, the first supplementary data based on the profile; and v) displaying, on a display, the first supplementary data in association with related data from the first document.

In another aspect, the present application describes a non-transitory computer readable storage medium storing computer-executable instructions which, when executed, cause a processor to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Described herein are techniques for automatically generating supplementary data, such as insurance rates, tax information or financing information, for a user based on the user's web browsing activity and displaying such supplementary data on a display. The described techniques maintain the privacy of certain user-specific data that may be used to generate the supplementary data. That is, such private data is not provided to third party websites (such as websites that a user might visit when shopping for cars, homes, appliances, etc.). Rather, the techniques described allow such private data to be maintained by a private server (which may be operating by a bank, insurance company, etc.) and supplementary data (e.g., a quote for financing, insurance, etc.) to be displayed alongside data from third party websites without revealing such private data (which may include data indicating a user's credit-worthiness, etc.) or supplementary data (e.g., which may be a quote for financing, insurance, etc.) to the third party websites. In at least some embodiments, the supplementary data may be displayed in real-time during browsing. That is, the supplementary data may be instantly generated based on a user's browsing activities (e.g., based on a particular car, house, etc. associated with a document, such as a webpage, that the user is currently viewing) and may be instantly displayed.

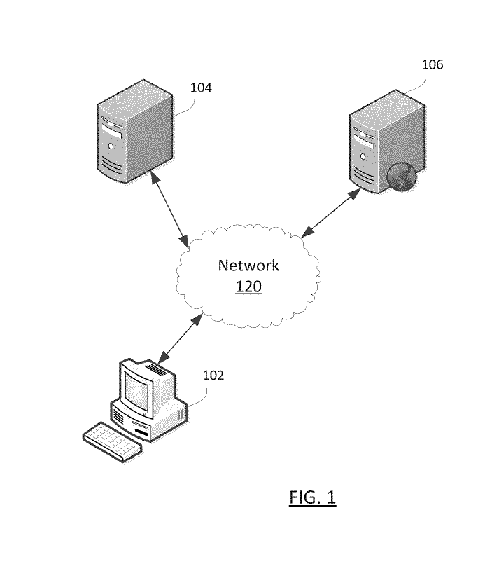

An overview having been provided, reference will now be made to FIG. 1 which illustrates a block diagram of an example operating environment in which embodiments of the present application may operate. FIG. 1 depicts an electronic device 102 in communication with servers through a network 120. The network 120 may include public and/or private networks including, for example, the Internet.

The electronic device 102 may be a computing device such as, for example, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), or any other type of computing device that may be configured to store data and software instructions, and execute software instructions to perform operations consistent with disclosed embodiments. In certain embodiments, the electronic devices may be associated with one or more users. For instance, a user may operate the electronic device, and may do so to cause the electronic devices to perform one or more operations consistent with the disclosed embodiments.

The servers that the electronic device 102 connects to through the network 120 may include servers of various types and that provide various functions. For example, a first server 104 may maintain and store profiles associated with a plurality of users and the first server 104 may generate and deliver supplementary data to electronic devices associated with such profiles. The second server 106 may be a web server, which may serve documents (and other resources), which may be in the form of web pages, to the electronic device. The second server 106 may, therefore, function as a website, and may process hypertext transfer protocol (HTTP) requests, serving documents and other resources in response to such requests.

In at least some embodiments, the second server 106 serves documents (to the electronic device 102 over the network 120) that include information about property, such as real property (e.g., real estate such as houses, land, commercial real estate, etc.), or goods, such as vehicles, consumer goods, appliances, etc. For example, the second server 106 may serve documents that identify features associated with real property that is available for sale. For example, a particular document may detail information regarding a specific property that is offered for sale or lease. Such information may include any one or combination of: the address of the property, the number of bedrooms, the number of bathrooms, a year of construction of the property, a price, etc. In some embodiments, the second server 106 may serve documents associated with numerous properties. For example, the second server 106 may function as an online real estate database. Example online real estate databases include Zillow™, realtor.Ca™, Zolo™, Zoocasa™, etc. It will be appreciated that the second server 106 may be an online real estate database different from those specifically identified above.

In some embodiments, the second server 106 may serve documents that identify features associated with vehicles, such as cars, trucks, motorcycles, vans, recreational vehicles (RVs), etc. that are available for sale. For example, a particular document may detail information regarding a specific vehicle that is available for sale or lease. Such information may include any one or a combination of: the make of the vehicle, the model of the vehicle, a year associated with the vehicle, mileage information, a price, etc. For example, the second server 106 may function as an online automobile database. Example automobile databases may include Autotrader™, Craigslist™, etc.

The second server 106 may serve other documents apart from those listed above. For example, the second server 106 may be an e-commerce website, for example, and may serve documents including information about goods (which may be consumer goods, appliances, or any other type of goods) available for purchase or services such as, for example, health care services or cosmetic surgery.

The second server 106 may serve documents of the type described above to the electronic device 102 in response to receiving an HTTP request for such resources from the electronic device 102. The HTTP request may, for example, be issued by an application module, such as a web browser, operating on the electronic device 102.

The documents that are served by the second server 106 may include documents of various types including, for example, text-based documents, multimedia documents, videos, audio files. In some embodiments, the documents may be hypertext markup language (HTML) documents.

As will be described in greater detail below, the electronic device 102 may be configured to monitor documents received at the electronic device from the second server 106. More specifically, the electronic device 102 may automatically parse such documents to identify one or more attributes of such documents. A supplementary data request may be issued to the first server 104 based on such attributes. As will be described in greater detail below, the first server 104 may generate supplementary data for delivery to the electronic device 102 that issued the supplementary data request. More particularly, the supplementary data request is received from an electronic device associated with a user that is associated with a profile stored at the first server 104. A profile associated with the user that is associated with the electronic device that issued the supplementary data request and information in the supplementary data request are used, by the first server 104, to generate supplementary data. The supplementary data is sent, over the network 120, from the first server 104 to the electronic device 102 that issued the supplementary data request.

The supplementary data is data that supplements or complements data in a document served from the second server 106 to the electronic device 102. For example, the supplementary data may be financing data (e.g., mortgage rate information or vehicle financing rate information, such as monthly payment information, interest rate information, etc.), tax data (such as sales tax information, property tax data, land transfer tax (which may also be referred to as stamp duty)) or insurance data (such as home or auto insurance data). The profile stored at the first server 104 defines user-specific data which includes information that allows the first server to determine such supplementary data. For example, the profile may include a credit score, asset information (such as a bank balance, etc.), income information, driver's license history data, claims history, etc. Information in the profile may be defined by a user (who may complete a questionnaire, for example, when first registering with the first server) or may be defined based on previous interactions with the user. For example, credit information may be determined by polling a credit agency server (not shown) with identifying information for the user associated with a profile. By way of further example, in some embodiments, the first server 104 may be associated with a financial institution and asset information may be determined based on account balances for the user at that financial institution. By way of yet further example, in some embodiments where the first server 104 is associated with a financial institution, income information may be automatically determined by the first server 104 based on recurring payroll deposits made into the user's accounts. Other techniques for determining profile data may be used instead of or in addition to the techniques described above.

The first server 104 may be operated by a financial institution such as a bank, an insurance company, or an organization of another type. The second server 106 is operated by a different entity than the first server 104 and the profile(s) stored at the first server 104 are maintained privately at the first server 104 and not revealed to the second server 106. Indeed, the supplementary data that is generated at the first server 104 may be generated based on documents served to the electronic device 102 from the second server 106, but the first server 104 provides such supplementary data directly to the electronic device 102 so that the supplementary data is not revealed to the second server 106.

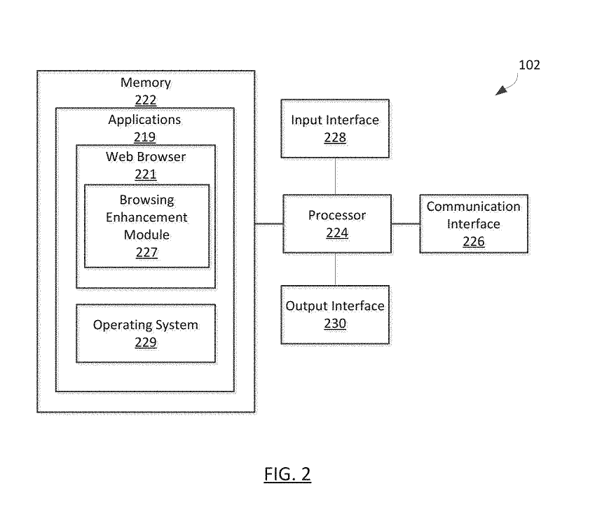

Reference will now be made to FIG. 2 which illustrates an example electronic device 102. The example electronic device 102 includes at least one processor 224. The processor 224 is coupled to a memory 222, a communication interface 226 and device subsystems such as one more input interface 228 (which may include a keyboard, touchscreen, camera, fingerprint sensor, button, etc.), one or more output interface 230 (which may be a display, speaker, vibrator, etc.) and other device subsystems.

The communication interface 226 may include subsystems for wired or wireless data communication. The communication interface 226 allows the electronic device 102 to send and receive data. For example, the communication interface 226 may allow electronic messages to be sent and received over a network, which may include the Internet. Among other things, the communication interface 226 may be used by the electronic device for communication with one or more servers such as, for example, the first server 104 and second server 106 of FIG. 1.

The memory 222 may include volatile and non-volatile memory. At least a part of the memory 222 may store processor-readable instructions that, when executed by the processor, cause the processor 224 to carry out some of the operations described herein. The processor-readable instructions are referred to as applications 219. The applications 219 may include, for example, an operating system 229 that may control overall device operations.

The applications 219 stored in the memory 222 may also include an application module which includes instructions for interacting with web servers, such as the second server 106 of FIG. 1. This application module may, for example, take the form of a web browser 221. The applications also include processor-executable instructions which, when executed by the processor 224 cause the electronic device 102 to interact with the first server 104 as described herein. Such instructions are referred to herein as a browsing enhancement module 227. The browsing enhancement module 227 may, for example, be provided on the electronic device 102 as a plug-in to the web browser 221. A web-browser plug-in extends the functionality of the web browser 221.

The electronic device 102 will include other components apart from those identified in FIG. 2 including, for example, a power source or an interface for connecting to a power source.

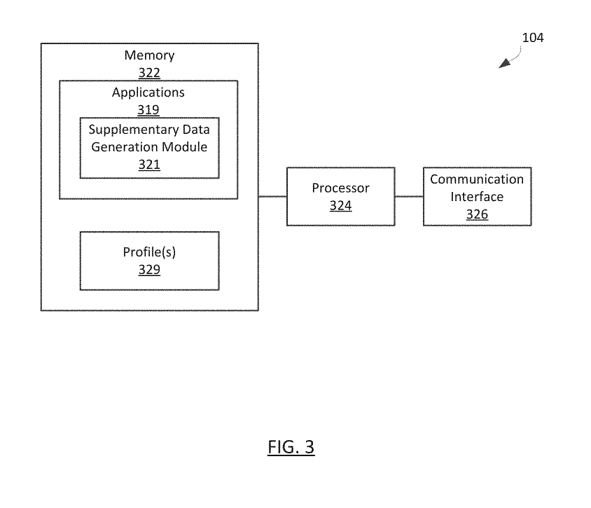

Reference will now be made to FIG. 3 which illustrates an example server. The example server may function as the first server 104 described above with reference to FIG. 1. The example first server 104 includes at least one processor 324. The processor 324 is coupled to a memory 322 and a communication interface 326. The processor may be coupled to other device subsystems not illustrated in FIG. 3 such as an input interface or an output interface.

The communication interface 326 may include subsystems for wired or wireless data communication. The communication interface 326 allows the first server 104 to send and receive data. For example, the communication interface 326 may allow electronic messages to be sent and received over the network 120 (FIG. 1). Among other things, the communication interface 326 may be used by the first server 104 for communication with one or more electronic devices 102.

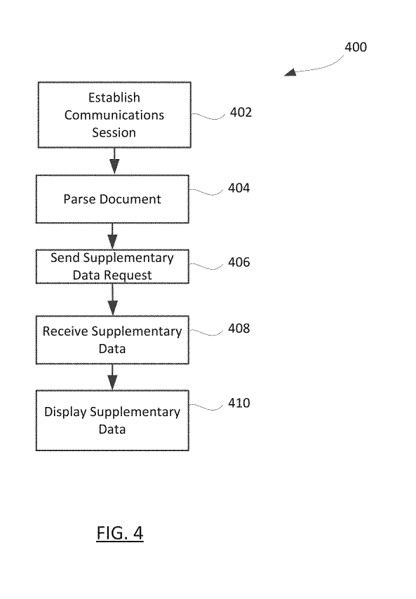

The memory 322 may include volatile and non-volatile memory. At least a part of the memory 322 may store processor-readable instructions (which may be referred to as applications 319) that, when executed by the processor, cause the processor 324 to carry out some of the operations described herein. The applications 219 stored in the memory 222 may include a supplementary data generation module 321. The supplementary data generation module 321 configures the processor to process supplementary data requests from electronic devices 102. More particularly, the supplementary data generation module 321 receives a supplementary data request from an electronic device and processes such a request to generate supplementary data and provides such data to the electronic device from which the request was received. The supplementary data is generated based on a profile for a user associated with the electronic device that sent the request. Accordingly, profile(s) 329 may be stored in memory 322. Among other things, the profiles may include or be associated with respective authentication data which may be used to authenticate authorization information (such as a password, biometric input, PIN, etc.) to ensure that the authorization information is associated with a user having a profile stored at the first server 104. As will be described below with reference to FIG. 4, the authorization information may be received via an input interface of the electronic device and may be provided, in an encrypted format, to the first server 104 as a proof-of-identity for a user of the electronic device. That is, the authorization information is used to allow a user to prove that they are associated with a profile 329 stored at the first server.

The first server 104 will include other components apart from those identified in FIG. 3 including, for example, a power source or an interface for connecting to a power source.

Reference will now be made to FIG. 4 which illustrates a flowchart of an example method 400 that may be performed by an electronic device 102 to obtain, from a first server 104, supplementary data based on a document obtained from a second server 106 (such as a web server). The method 400 may be performed by a processor 224 which executes processor-executable instructions stored in memory 222. The processor executable instructions may be provided in applications 219 or modules such as a browsing enhancement module 227 (FIG. 2). For example, the browsing enhancement module 227 may, when executed, configure the electronic device to perform the method 400.

At operation 402, the electronic device 102 establishes a communications session with the first server. The communications session is established via a communication interface 226 (FIG. 2) of the electronic device 102. The communications session is established based on authorization information that is received at an input interface 228 (FIG. 2) of the electronic device 102. The input interface may be a keyboard, touchscreen, camera, biometric reader such as a fingerprint sensor, or an input interface of another type. The authorization information may be proof-of-identity data such as a password, PIN, biometric input such as a fingerprint, or other data. During operation 402, the electronic device 102 may send the authorization information in an encrypted form to the first server 104 for validation. Upon validation of the authorization information using authentication data stored at the first server (e.g., upon determining that the authorization information is associated a profile stored at the first server since the authorization information is valid based on the authentication data in the profile), a communications session may be established. The communications session is a trusted session which allows the electronic device 102 and the first server 104 to subsequently exchange communications without having to input the authorization information at each exchange. A session identifier (ID) may be established during operation 402 and the session ID may be used in subsequent communications.

The session may be established at operation 402 automatically; for example, when the browsing enhancement module 227 is first executed, or after the first execution of the browsing enhancement module 227 following execution of a web browser. Other trigger conditions may cause operation 402 to be performed in other embodiments. Once a session is established, the session may terminate due to termination of the browsing enhancement module 227 or termination of a web browser, or due to detection of another triggering condition. In some embodiments, after termination of the session, input of authorization information may again be used for a further session to be established. In some embodiments, authorization information, once input, may be stored locally on the electronic device 102 so that input of such information is not required each time a session is instantiated. For example, in such embodiments, during operation 402 the electronic device 102 may retrieve the authorization information from memory.

The electronic device 102 retrieves a document or another resource from a second server 106, which may be a web server. This document may be retrieved, for example, by an application module such as a web browser in response to an input of an instruction to retrieve the document. The instruction may be input via an input interface of the electronic device. The instruction may cause an HTTP request for the document or other resource to be sent to the second server 106 and the second server may then send the document or other resource to the electronic device. The retrieved document may be displayed within the application module that issued the HTTP request. For example, the retrieved document may be displayed within a web browser.

At operation 404, the electronic device 102 parses the document retrieved by the application module to identify one or more attributes of the document. The parsing of the document may be performed automatically by a processor of the electronic device and may be performed as a background process on the electronic device. To identify attributes of the document at operation 404, the electronic device may first categorize the document and may then identify the one or more attributes based on the category of the first document. For example, the browsing enhancement module 227 may configure the processor to identify certain categories of documents including, for example, real estate documents (e.g., which identify or describe a house, land, commercial property, industrial property, cottage, etc. that is offered for lease or sale), automobile-related documents (e.g., which identify or describe a car, truck, van, tractor trailer, tractor, recreational vehicle, motorcycle, etc. that is offered for sale or lease), e-commerce documents (e.g., which identify or describe appliances, consumer electronics, etc. that are offered for sale), or other categories of documents. Once a category of a document is determined, the category may affect the types of attributes that the electronic device 102 attempts to identify. For example, at least some of the attributes that the electronic device 102 attempts to identify in a document when the document is a real estate document may be different than attributes that the electronic device 102 attempts to identify in a document when the document is an automobile-related document.

By way of example, for a real estate document, the electronic device 102 may identify one or more of the following attributes in a document: price data, geographic location data (i.e., the location of the property, house, etc.), or house feature data. House feature data includes data that may affect a home insurance rate such as, for example, security system presence data (i.e., data indicating whether a security system exists), square footage data (i.e., data indicating the square footage of the house), wood burning fireplace data (i.e., data indicating the existence of a wood burning fireplace or stove in the house), electrical data (which may indicate the presence or absence of knob and tube wiring, aluminum wiring, or an amperage of service), waterfront proximity data (which may indicate whether the property is on the water), age-of-roof data (which may indicate a date when a roof was last replaced), year-built information (which indicates a date when property was constructed), or data of another type.

By way of further example, for an automobile-related document, the electronic device may identify one or more of the following attributes in a document: price data, the make of the automobile, the model of the automobile, a year associated with the automobile, mileage information, etc.

Attributes in the document may be identified through keyword analysis techniques and/or by applying natural language processing to the text of the document. Document categorization may involve similar techniques. For example, to categorize the document, the electronic device may perform a keyword-based automated analysis of the document. For example, categorization may be performed based on keyword and/or pattern searching on the document. Terms in the document such as “house”, “home”, etc. may indicate that the webpage identifies a house for sale whereas “car”, “truck”, etc. may indicate that the document identifies a car for sale.

Image-based analysis techniques may also be used in the categorization based on images on the first document.

Other techniques may also be used to categorize the document instead of or in addition to text-based analysis techniques. For example, the document may be categorized using image-based analysis techniques. For example, pictures of a house contained in the document may be interpreted as an indicator that the document is a real estate related document whereas pictures of an automobile contained in the document may be interpreted as an indicator that the document is an automobile-related document. In at least some embodiments, the electronic device 102 may use an address associated with the document to categorize the document. The address may be a uniform resource locator (URL) used to retrieve the document and the categorizing may compare the URL or a portion of the URL to one or more URLs that have been predefined for a category (e.g., certain URLs may be defined for a first category, such as real estate documents and other URLs may be defined for a second category, such as automobile-related documents). For example, when the URL for the retrieved document is associated with an online real estate database, the electronic device may determine that the document is a real estate document and when the URL is associated with an online automobile database, the electronic device may determine that the document is an automobile-related document.

In some embodiments in which the document is or includes a video, the video may be pre-processed to identify text displayed in frames of the video or to identify text from speech in the video (or speech in an audio file if the document includes an audio file). Such text may then be used to categorize the document.

At operation 406, during the communications session established at operation 402, the electronic device transmits a signal to the first server 104 via the communication interface 226. The signal represents a supplementary data request. The first supplementary data request is based on one or more of the identified attributes for the document. For example, one or more of the attributes identified at operation 404 may be included in the supplementary data request sent at operation 406. The supplementary data request may also include the category identified at operation 404. The supplementary data request may include the session ID for the session established at operation 402.

At operation 408, in response to sending the supplementary data request, the electronic device 102 receives supplementary data from the first server 104. The supplementary data is based on the profile associated with the authorization information received at operation 402 and also based on at least a portion of the attributes identified at operation 404, which may have been sent at operation 406. The supplementary data may also be based on the category of the document identified at operation 404. The supplementary data received at operation 408 may include financing data (such as mortgage rate information, which may include any one or a combination of a monthly payment, an amortization period, a term, a rate which may be expressed as a number of basis points, etc.), tax data (such as sales tax information, property tax data, land transfer tax) and/or insurance data (such as home insurance data or automobile insurance data).

The supplementary data received at operation 408 may specify certain data or assumptions are that associated with a quote or estimate. For example, if during the parsing it was determined that a home represented by a document includes a security system and if this affected the rate, then the home insurance information may specify that the quoted rate assumes that the house has an operating security system.

At operation 410, the electronic device displays, on a display of the electronic device, the supplementary data. The supplementary data may be displayed in association with related data from the document that was parsed at operation 404. The supplementary data may be displayed in real-time after retrieving the first document. That is, the supplementary data may be instantly displayed when the document is retrieved.

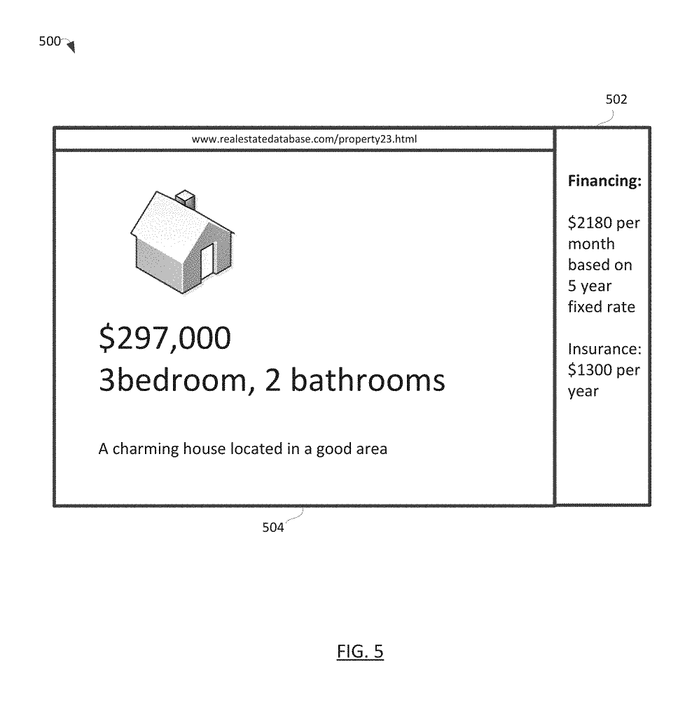

Referring now to FIG. 5, an example display screen 500 is illustrated. The example display screen may be displayed at operation 410 of the method 400 of FIG. 4. The example display includes a document 504 which is displayed within a web-browser area concurrently while supplementary data generated based on attributes identified from the document 504 are displayed in a supplementary data portion 502 of the display screen 500. The supplementary data illustrated includes financing and insurance information generated for a property identified in the document 504. As described above with reference to FIG. 4, the supplementary data may be user-specific. That is, the supplementary data is generated based on data in a profile associated with the user.

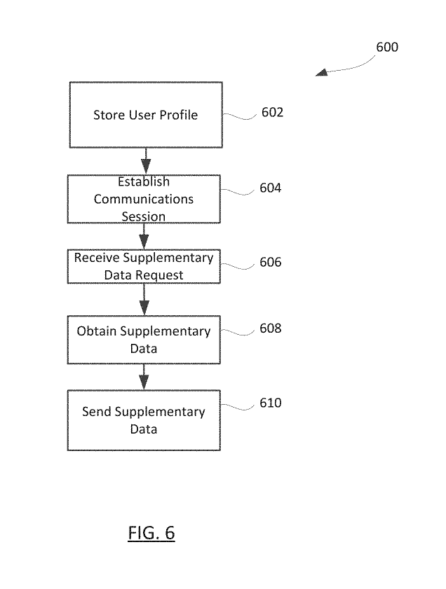

Reference will now be made to FIG. 6 which illustrates a flowchart of an example method 600 that may be performed by a first server 104 to provide supplementary data to an electronic device. The method 600 may be performed by a processor 324 which executes processor-executable instructions stored in memory 322. The processor executable instructions may be provided in applications 319 or modules such as a supplementary data generation module 321 (FIG. 3). For example, the supplementary data generation module 321 may, when executed, configure the electronic device to perform the method 600.

At operation 602, the first server 104 stores a user profile. The profile stored at the first server 104 defines user-specific data which includes information that allows the first server to determine the supplementary data. For example, the profile may include a credit score, asset information (such as a bank balance, etc.), income information, driver's license history data, claims history, etc. Information in the profile may be defined by a user (who may complete a questionnaire, for example, when first registering with the first server) or may be defined based on previous interactions with the user. For example, credit information may be determined by polling a credit agency server (not shown) with identifying information for the user associated with a profile. By way of further example, in some embodiments, the first server 104 may be associated with a financial institution and asset information may be determined based on account balances for the user at that financial institution. By way of yet further example, in some embodiments where the first server 104 is associated with a financial institution, income information may be automatically determined by the first server 104 based on recurring payroll deposits made into the user's accounts. Other techniques for determining profile data may be used instead of or in addition to the techniques described above.

At operation 604, the first server 104 establishes a communications session with the electronic device 102. The communications session is established via a communication interface 326 of the first server 104. The communications session is established based on authorization information that is received at an input interface 228 (FIG. 2) of the electronic device 102. The first server 104 receives the authorization information and authenticates the authorization information based on previously-define authentication data stored in association with the profile at the electronic device 102. A session ID may be defined for the session at operation 604.

At operation 606, the first server 104 receives the supplementary data request issued by the electronic device 102 at operation 406 of the method 400 of FIG. 4. The supplementary data request may include one or more attributes identified from a document retrieved at the electronic device. The first server 104 may obtain supplementary data at operation 608 based on data contained in the supplementary data request (such as one or more attributes for the document, category information for the document, etc.) and based on a profile associated with a user for whom the communications session was established at operation 604. For example, a user-specific quote or rate may be generated at operation 608. For example, an insurance rate, financing rate, tax rate, etc. that is specific to the user (i.e., generated based on data in the profile for that user) may be generated by the first server 104. The supplementary data that is generated is also specific to the first document. That is, the attributes that were identified in the first document are used to generate the supplementary data. For example, where the first document illustrates a house, the supplementary data may represent a quote for insurance or a quote for financing for that house.

The supplementary data is sent to the electronic device at operation 610 of the method 600 over the communication interface 326.

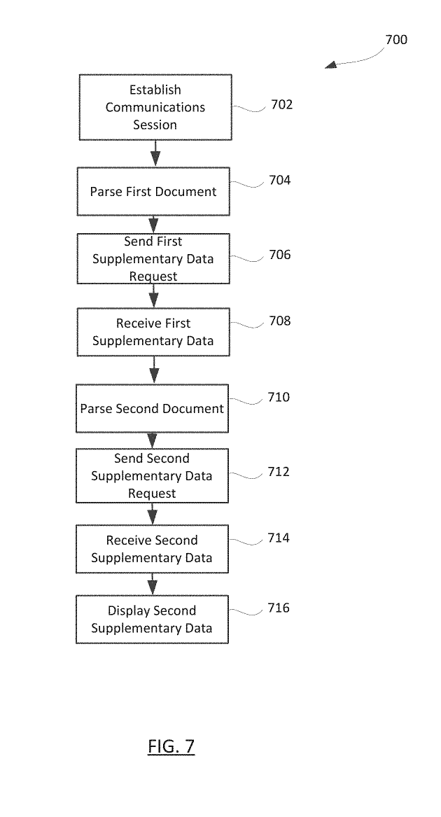

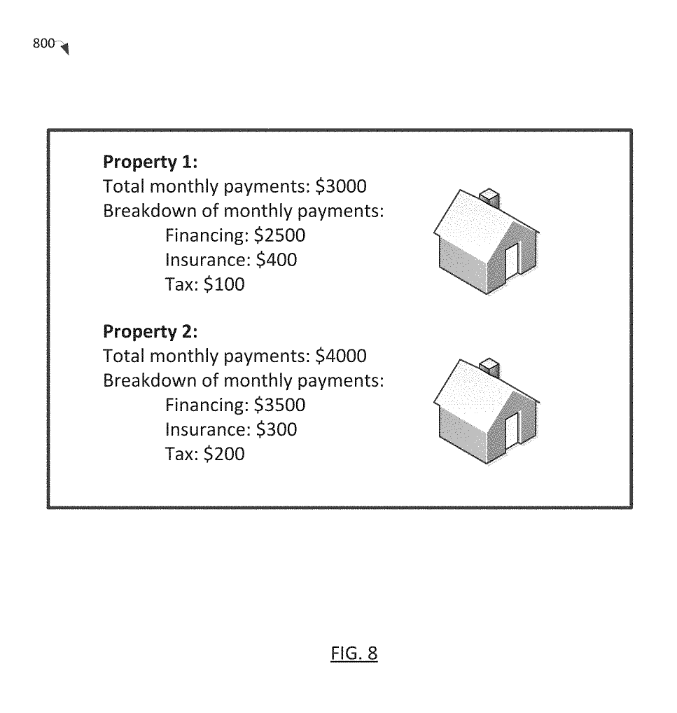

In at least some embodiments, the electronic device 102 may be configured to generate a display screen 800, an example of which is displayed in FIG. 8, based on first supplementary data generated based on a first document and second supplementary data generated based on a second document. Such a display screen provides a comparison view which allows the supplementary data for these different documents to be compared. An example method 700 for generating such a display will now be described with reference to FIG. 7.

The example method 700 may be performed by an electronic device 102. More particularly, the method 700 may be performed by a processor 224 which executes processor-executable instructions stored in memory 222. The processor executable instructions may be provided in applications 219 or modules such as a browsing enhancement module 227 (FIG. 2). For example, the browsing enhancement module 227 may, when executed, configure the electronic device to perform the method 700.

At operation 702, the electronic device establishes a communications session with the first server 104. Operation 702 may be performed in the manner described above with reference to operation 402 of the method 400 of FIG. 4.

At operation 704, the electronic device may parse a first document retrieved by the application module to identify one or more attributes as described above with reference to operation 404 of the method 400 of FIG. 4.

At operation 706, the electronic device may, during the communications session, transmit a signal to the first server via the communication interface. The signal represents a first supplementary data request. The first supplementary data request is based on one or more of the identified attributes for the first document. Operation 706 may be performed in the manner described above with reference to operation 406 of the method 400 of FIG. 4.

At operation 708, the electronic device may receive first supplementary data from the first server. The first supplementary data may be generated based on the profile and attributes, as described above with reference to operation 608 of the method 600 of FIG. 6. Operation 708 may be performed in the manner described above with reference to operation 408 of the method 400 of FIG. 4.

The first supplementary data may be displayed on the display (as described above with reference to operation 410 of the method 400 of FIG. 4) or it may be stored in memory of the electronic device for future use.

After the first supplementary data is received, a second document may be retrieved at the electronic device by the application module. The electronic device may then, at operation 710 parse the second document to identify one or more attributes for the second document. Operation 710 may be performed in the manner as operation 404 of the method 400 of FIG. 4.

Then, during the communications session established at operation 702, the electronic device may, at operation 712, transmit a second signal to the first server via the communication interface. The second signal represents a second supplementary data request. The second supplementary data request is based on one or more of the identified attributes for the second document. Operation 712 may be performed in the manner described above with reference to operation 406 of the method 400 of FIG. 4, except that operation 712 generates the second supplementary request based on attributes identified from the second document.

At operation 714, the electronic device receives second supplementary data from the first server. The second supplementary data is based on the profile. Operation 714 is performed in the manner described above with reference to operation 708 and operation 408 of the method 400 of FIG. 4, except that the second supplementary data received at operation 714 relates to the second document and not the first. That is, the attributes identified in the second document were used by the first server to generate the second supplementary data.

At operation 716, the electronic device displays the second supplementary data in association with related data from the second document while concurrently displaying the first supplementary data in association with related data from the first document. That is, a display screen 800 may be generated which provides a side-by-side comparison of the first supplementary data and the second supplementary data. For example, the display screen 800 of FIG. 8 compares a rate for property (e.g., monthly payment amount, etc.) described in the first document with a rate for property described in the second document. In the illustrated example, a total payment rate (expressed as a monthly payment rate) is illustrated together with itemized rates (e.g., a mortgage rate which is expressed as a monthly mortgage payment, an insurance rate expressed as a monthly rate and/or a tax rate expressed as a monthly payment towards property tax).

Variations of the techniques described herein may also be used. For example, in some embodiments, the supplementary data request is not sent automatically. Instead, the attributes identified from the document may be used to automatically populate fields of a form which may be displayed on the electronic device. The form may be a supplementary data request form which may define data that may be used by the first server to generate supplementary data. For example, any one or more of the following form fields may be included and may be automatically populated based on attributes identified in the document: price data, geographic location data (i.e., the location of the property, house, etc.), security system presence data (i.e., data indicating whether a security system exists), square footage data (i.e., data indicating the square footage of the house), wood burning fireplace data (i.e., data indicating the existence of a wood burning fireplace or stove in the house), electrical data (which may indicate the presence or absence of knob and tube wiring, aluminum wiring, or an amperage of service), waterfront proximity data which may indicate whether the property is on the water, age-of-roof data which may indicate a date when a roof was last replaced, year-built information which indicates a date when property was constructed, or data of another type.

Automatic document categorization as described above with reference to operation 404 may be used to select an appropriate form from a plurality of pre-defined forms for display. For example, when a document that has been retrieved is a real estate document, then a real estate form may be displayed and where the document that has been retrieved is an automobile-related document, then an automotive form may be displayed. By way of example, the automotive form may include fields to specify a make and model of a vehicle whereas the real estate form may not.

The form may be transmitted to the first server after display of the form upon receipt of an instruction via an input interface authorizing the transmission of the form. The form may allow a user to edit or supplement data before submitting the form.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

Certain adaptations and modifications of the described embodiments can be made. Therefore, the above discussed embodiments are considered to be illustrative and not restrictive.

What is claimed is:

1. An electronic device comprising:
an input interface;
a display;
a communication interface;
a memory storing an application module; and
a processor coupled to the input interface, the communication interface, the display and the memory, the processor configured to:
establish a communications session via the communication interface with a first server based on authorization information received at the input interface, the authorization information associated with a profile stored at the first server;
parse a first document retrieved by the application module to identify one or more attributes;
during the communications session, transmit a signal to the first server via the communication interface, the signal representing a first supplementary data request, the first supplementary data request based on one or more of the identified attributes for the first document;
receive first supplementary data from the first server, the first supplementary data based on the profile; and
display on the display the first supplementary data in association with related data from the first document.

2. The electronic device of claim 1, wherein the processor is further configured to:
parse a second document retrieved by the application module to identify one or more attributes for the second document;
during the communications session, transmit a second signal to the first server via the communication interface, the second signal representing a second supplementary data request, the second supplementary data request based on one or more of the identified attributes for the second document;
receive second supplementary data from the first server, the second supplementary data based on the profile; and
display on the display the second supplementary data in association with related data from the second document while concurrently displaying the first supplementary data in association with related data from the first document.

3. The electronic device of claim 1, wherein the processor is configured to display the first supplementary data in real-time after retrieving the first document.

4. The electronic device of claim 1, wherein parsing the first document comprises:
categorizing the first document; and
identifying the one or more attributes based on a category of the first document.

5. The electronic device of claim 4, wherein categorizing the first document comprises determining that the first document is a real estate document and wherein identifying the one or more attributes comprises identifying one or more of:
price data;
geographic location data; or
house feature data.

6. The electronic device of claim 5, wherein the first supplementary data comprises one or more of:
financing data;
tax data; or
home insurance data.

7. The electronic device of claim 4, wherein categorizing the first document comprises determining that the first document is an automobile-related document and wherein identifying the one or more attributes comprises identifying one or more of a price, a make, or a model.

8. The electronic device of claim 7, wherein the first supplementary data comprises one or more of:
financing data;
tax data; or
auto insurance data.

9. The electronic device of claim 4, wherein the first document is categorized by comparing at least a portion of an address associated with the first document to one or more addresses defined for a first category.

10. The electronic device of claim 4, wherein categorizing the first document comprises performing a keyword-based automated analysis of the first document.

11. A computer-implemented method comprising:
establishing a communications session between an electronic device and a first server based on authorization information received at an input interface associated with the electronic device, the authorization information associated with a profile stored at the first server;
parsing, by the electronic device, a first document retrieved by an application module to identify one or more attributes;
during the communications session, transmitting a signal to the first server via a communication interface of the electronic device, the signal representing a first supplementary data request, the first supplementary data request based on one or more of the identified attributes for the first document;
receiving first supplementary data from the first server, the first supplementary data based on the profile; and
displaying, on a display, the first supplementary data in association with related data from the first document.

12. The computer-implemented method of claim 11, further comprising:
parsing, by the electronic device, a second document retrieved by the application module to identify one or more attributes for the second document;
during the communications session, transmitting a second signal to the first server via the communication interface, the second signal representing a second supplementary data request, the second supplementary data request based on one or more of the identified attributes for the second document;
receiving second supplementary data from the first server, the second supplementary data based on the profile; and
displaying the second supplementary data in association with related data from the second document while concurrently displaying the first supplementary data in association with related data from the first document.

13. The computer-implemented method of claim 11, wherein the display displays the first supplementary data in real-time after retrieving the first document.

14. The computer-implemented method of claim 11, wherein parsing the first document comprises:
categorizing the first document; and
identifying the one or more attributes based on a category of the first document.

15. The computer-implemented method of claim 14, wherein categorizing the first document comprises determining that the first document is a real estate document and wherein identifying the one or more attributes comprises identifying one or more of:
price data;
geographic location data; or
house feature data.

16. The computer-implemented method of claim 15, wherein the first supplementary data comprises one or more of:
financing data;
tax data; or
home insurance data.

17. The computer-implemented method of claim 14, wherein categorizing the first document comprises determining that the first document is an automobile-related document and wherein identifying the one or more attributes comprises identifying one or more of a price, a make, or a model.

18. The method of claim 17, wherein the first supplementary data comprises one or more of:
financing data;
tax data; or
auto insurance data.

19. The method of claim 14, wherein the first document is categorized by comparing at least a portion of an address associated with the first document to one or more addresses defined for a first category.

20. A non-transitory computer-readable storage medium comprising processor-executable instructions which, when executed, configure a processor to:
establish a communications session between an electronic device and a first server based on authorization information received at an input interface associated with the electronic device, the authorization information associated with a profile stored at the first server;
parse, by the electronic device, a first document retrieved by an application module to identify one or more attributes;
during the communications session, transmit a signal to the first server via a communication interface of the electronic device, the signal representing a first supplementary data request, the first supplementary data request based on one or more of the identified attributes for the first document;
receive first supplementary data from the first server, the first supplementary data based on the profile; and
display the first supplementary data in association with related data from the first document.
